(19) United States
(12) Patent Application Publication
(10) Pub. No.: US 2019/0297836 A1
(43) Pub. Date: Oct. 3, 2019

(54) Animal Suspension Harness

(71) Applicant: Sandra Roa, Pacific Palisades, CA (US)

(72) Inventor: Sandra Roa, Pacific Palisades, CA (US)

(21) Appl. No.: 16/292,764

(22) Filed: Mar. 5, 2019

Related U.S. Application Data
(60) Provisional application No. 62/649,982, filed on Mar. 29, 2018.

(51) Int. Cl. A01K 1/02; A01K 27/00

(52) U.S. Cl. CPC A01K 1/0263; A01K 27/002

(57) ABSTRACT

An animal suspension harness designed to support an animal in an upright position to properly digest their food when fed. The animal suspension harness includes a frame having a plurality of legs extending therefrom such that the frame is freestanding. At least one crossbar extends between two orthogonally adjacent legs. A harness, having a first end and a second end, with a central body disposed between, wherein the central body includes at least one rear aperture configured to accept a tail therethrough. The first end of the harness includes at least one suspension strap removably secured to the crossbar. The second end includes at least one body strap removably secured to the frame. In this way, a user is able to support an animal in an upright position to properly digest their food while eating without risk of complications, such as choking.

### CROSS REFERENCE TO RELATED APPLICATIONS

This application claims the benefit of U.S. Provisional Application No. 62/649,982 filed on Mar. 29, 2018. The above identified patent application is herein incorporated by reference in its entirety to provide continuity of disclosure.

### BACKGROUND OF THE INVENTION

The present invention relates to animal harnesses. More specifically, the invention provides a frame with a crossbar and a harness affixed to each end of the frame via a suspension strap on one end and a body strap on an opposing end. B

Many pets, such as dogs, suffer from enlarged esophagi. Unfortunately, an enlarged esophagus makes it difficult for the animal to eat safely in a normal capacity. Often, these animals are traditionally fed from a bowl on a floor, leading to the pets eating face down which eventually results in medical complications, and could result in death. Although it is possible for a person to feed their pet manually in an upright position, it can be difficult for the person to support the animal for extending periods of time. Thus, an improved animal suspension harness that can efficiently support an animal in an upright position to properly digest food while being fed is desired.

Additionally, when pets are held in an upright position, digestion may further be aided by maintaining an upright position for a longer period of time, thus aiding digestion as gravity allows for the food to pass through the stomach with greater ease. However, a user may not desire to hold their pet manually in an upright position for an extended period of time. Therefore, a defined need exists for a device that provides continuous support to a pet being fed in an upright position.

### SUMMARY OF THE INVENTION

In view of the foregoing disadvantages inherent in the known types of animal harnesses now present in the known art, the present invention provides an animal suspension harness wherein the same can be utilized for providing convenience for the user when desiring to support an animal in an upright position to properly digest their food while eating without risk of complications.

The present system comprises an animal suspension harness. The animal suspension harness comprises a frame having a plurality of legs extending therefrom such that the frame is freestanding. At least one crossbar extends between two orthogonally adjacent legs. A harness, having a first end and a second end, with a central body disposed between, wherein the central body includes at least one rear aperture configured to accept a tail therethrough. The first end of the harness includes at least one suspension strap removably secured to the crossbar. The second end includes at least one body strap removably secured to the frame. In this way, a user is able to support an animal in an upright position to properly digest their food while eating without risk of complications.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the animal suspension harness.

FIG. 2 shows a perspective view of an embodiment of the crossbar and frame of the animal suspension harness.

FIG. 3 shows a perspective view of an embodiment of the suspension harness of the animal suspension harness.

FIG. 4 shows a perspective view of an embodiment of the animal suspension harness in use.

### DETAILED DESCRIPTION OF THE INVENTION

Reference is made herein to the attached drawings. Like reference numerals are used throughout the drawings to depict like or similar elements of the animal suspension harness. The figures are intended for representative purposes only and should not be considered to be limiting in any respect.

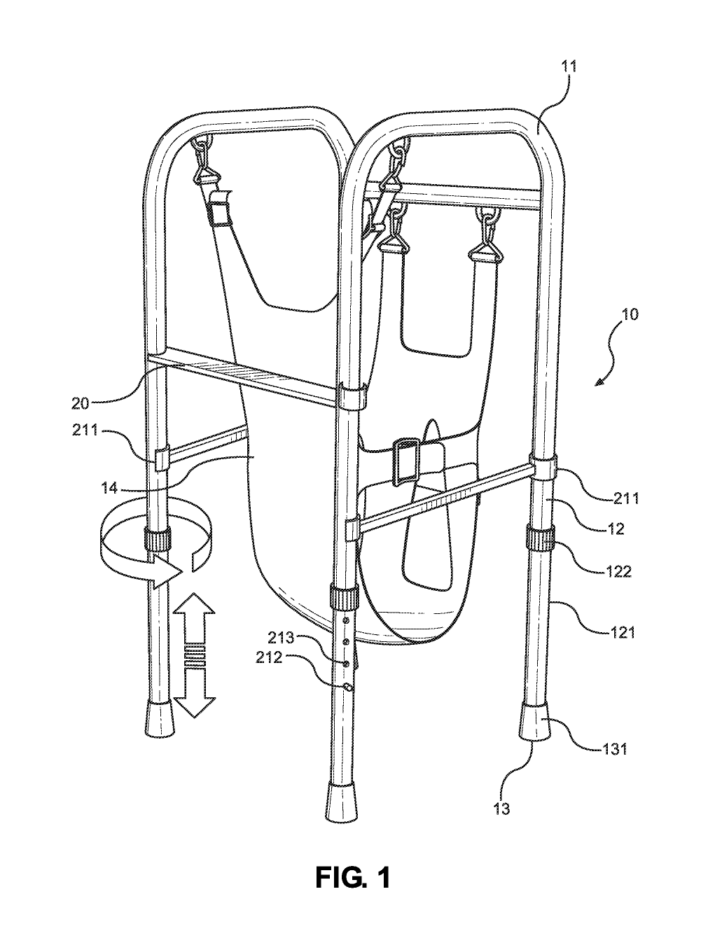

Referring now to FIG. 1, there is shown a perspective view of an embodiment of the animal suspension harness. An animal suspension harness 10 comprises a frame 11, having a plurality of legs 12 extending outwardly therefrom. In the illustrated embodiment, each leg 12 extends outwardly from the frame 11 to an equivalent length along an equivalent direction. In the illustrated embodiment, the plurality of legs 12 comprises four legs, each having a distal end 13 disposed opposite the frame 11. The distal end 13 of each leg 12 includes a stopper 131 thereon, wherein the stopper 131 is composed of a material having a friction coefficient greater than one, such that the legs 12 do not slide without undue force thereby applied. In one embodiment, the frame 11 further comprises at least one support bar 211 removably disposed between a pair of legs of the plurality of legs 12. In the illustrated embodiment, the at least one support bar 211 comprises a pair of clips configured to tensionably secure to the frame 11, wherein a clip is disposed on each end of each support bar 211.

In the illustrated embodiment, each leg 12 is telescopic such that a lower portion 121 can recede into or extend out of a main body of the leg 12. In the shown embodiment, the amount of the lower portion 121 exposed is determined by a control mechanism 122. In this way, the user can control the total height of the frame 11, allowing them to customize the frame 11 to their desired height. In the illustrated embodiment, the control mechanism 122 comprises a rotatable collar, such that rotating the collar 122 in a first direction causes the lower portion 121 to extend and rotating the collar 122 in an opposite direction causes the lower portion 121 to recede.

In an alternate embodiment, shown on a leg of the plurality of legs 12 in FIG. 1, the control mechanism 122 comprises a tensioned push button 212 in an operable configuration with a plurality of apertures 213. As such, the push button 212 can be pushed inward to slidably engage lower portion 121 to adjust the height of the animal suspension harness 10.

The animal suspension harness 10 further comprises a harness 14 removably secured to the frame 11, wherein the harness 14 is configured to support an animal, such as a dog, upright therein. In the illustrated embodiment, the harness 14 is suspended between the plurality of legs 12. The harness 14 is affixed to the frame 11 via a plurality of connection points, enabling the user to securely support an animal therein, while evenly distributing the weight of the animal across then entirety of the frame 11. In the illustrated embodiment, a paw rest 20 extends between opposing legs of the plurality of legs 12, wherein the paw rest 20 is configured to provide a support to the legs of an animal disposed within the harness 14. In some embodiments, the paw rest 20 comprises a flexible planar member.

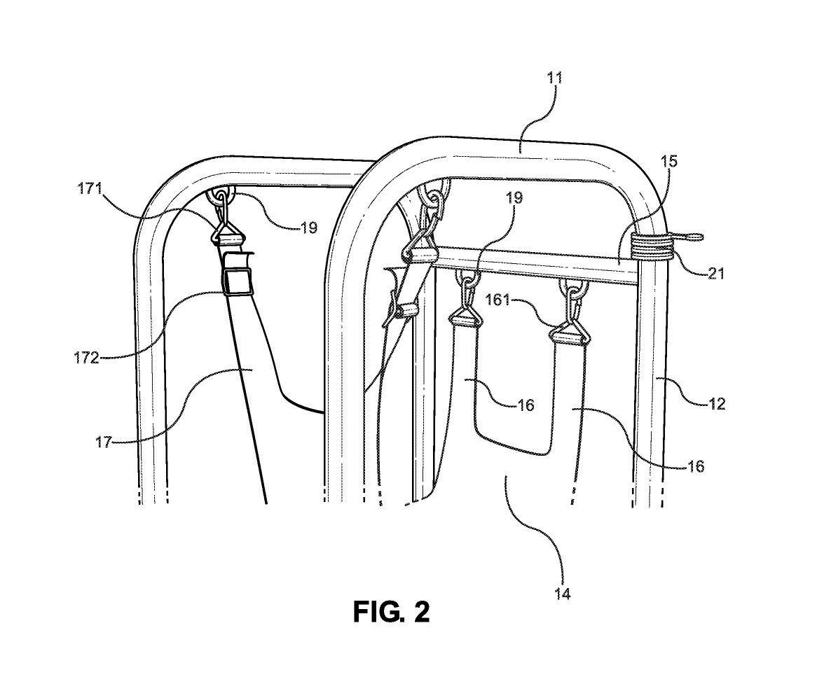

Referring now to FIG. 2, there is shown a perspective view of an embodiment of the crossbar and frame of the animal suspension harness. The frame 11 further comprises a crossbar 15 secured between two orthogonally adjacent legs 12. In the illustrated embodiment, the crossbar 15 is permanently secured therebetween, however in further embodiments the crossbar 15 is removably securable such that the user can position the crossbar 15 between any two legs at any desired height. In the illustrated embodiment, the frame 11 is pivotally affixed to the crossbar 15 and further comprises a lever 21 disposed thereon, the lever 21 configured to allow the frame 11 to selectively move between a collapsed position and a deployed position when actuated. In the collapsed position, the frame 11 rests substantially parallel to the crossbar 15 to provide a minimal form factor for ease of storage and transport.

The harness 14 includes a suspension strap 16 removably secured to the crossbar 15. In the illustrated embodiment, the suspension strap 16 is composed of two individual straps to reduce the strain produced by the harness 14. In some embodiments, the suspension strap 16 is adjustable in length to allow a user to customize the harness 14 for animals of various sizes. Additionally, the harness 14 comprises a pair of body straps 17 disposed on opposing sides of the harness 14, wherein the body straps 17 are removably secured to the frame 11. In the shown embodiment, the body straps further comprise tightening straps 172, thereby allowing the user adjust the height of the body straps 17.

In the illustrated embodiment, a plurality of D-rings 19 are disposed along the frame 11 and the crossbar 15, wherein the D-rings are configured to secure to and support the harness 14. In the shown embodiment, the suspension straps 16 are secured to the D-rings 19 along the crossbar 15 via suspension fasteners 161, while the body straps 17 are secured to the D-rings along the frame 11 via body strap fasteners 171. In the illustrated embodiment, the suspension fasteners 161 and body strap fasteners 171 are pivotally affixed to the D-rings 19, such that the harness 14 can easily be untangled regardless of how the harness 14 is positioned.

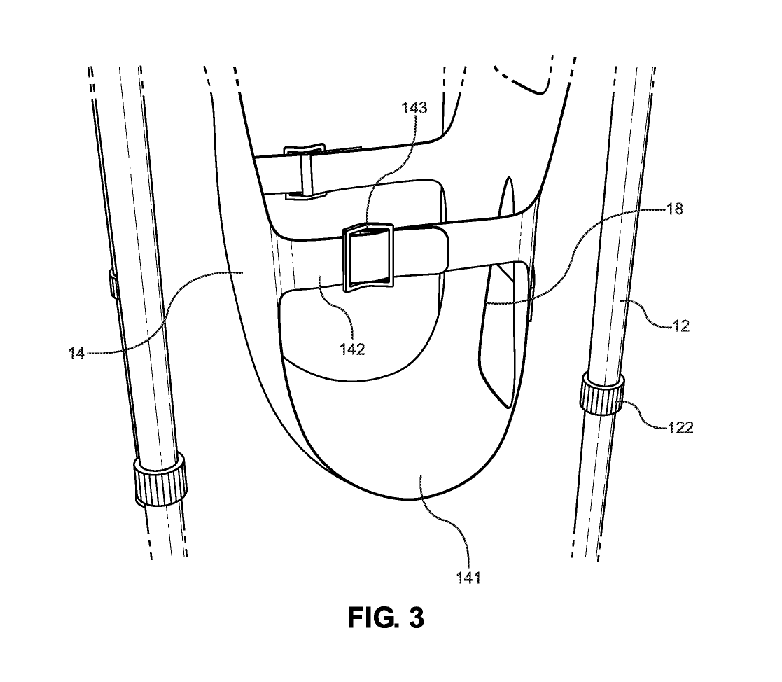

Referring now to FIG. 3, there is shown a perspective view of an embodiment of the harness of the animal suspension harness. The harness 14 is disposed centrally between the plurality of legs 12, such that any animal placed therein is supported equally by all legs 12 and the animal suspension harness is thereby balanced. In the illustrated embodiment, the control mechanism 122 on the legs 12 comprises a grooved surface thereon, thereby providing a frictional engagement with the individual when used.

The harness 14 includes an apex 141 configured to support the bulk of the body of the animal placed within the harness 14. A plurality of main straps 142 are disposed along the harness 14 and configured to provide the majority of support to the animal placed therein. In the illustrated embodiment, the main straps 142 further comprise a tightening mechanism 143, such that the main straps 142 can be secured therearound the body of the animal placed within the harness 14.

The harness 14 further comprises a rear aperture 18 configured to accept a tail of the animal therethrough. As such, the rear aperture 18 is appropriately dimensioned and positioned. In the illustrated embodiment, the rear aperture 18 is oriented such that the rear aperture 18 is aligned with the crossbar to ensure the rear half of the animal is secured. However, in other embodiments the harness 14 can be secured to the frame such that the rear aperture 18 is not aligned with the crossbar to ensure the tail of the animal is not trapped in an uncomfortable position between the harness 14 and the crossbar.

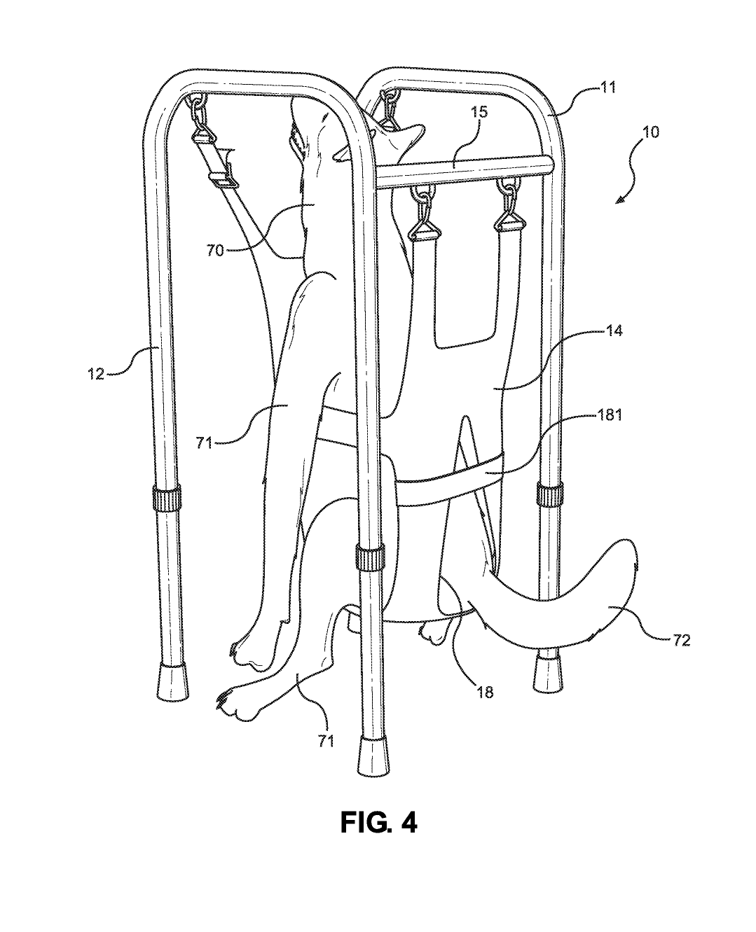

Referring now to FIG. 4, there is shown a perspective view of an embodiment of the animal suspension harness in use. In operation, a user will affix the harness 14 to the frame 11 and crossbar 15, thereby allowing them to place an animal 70, such as a dog, into the animal suspension harness 10. The animal 70 is oriented in the harness 14 such that the animal legs 71 are outside the harness 14 and aligned with the legs 12 of the frame 11 while the rear aperture 18 is configured to accept the tail 72 therethrough. In the illustrated embodiment, the rear aperture 18 further comprises tail secure strap 181 to secure the tail 72 in a desired position if necessary. In this way, a user can easily secure their animal in an upright position without causing the animal undue stress, thereby allowing the user to feed the animal safely.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An animal suspension harness, comprising:
a frame having a plurality of legs extending therefrom such that the frame is freestanding;
at least one crossbar extending between two orthogonally adjacent legs of the plurality of legs;
a harness having a first end and a second end, wherein a central body support is disposed at a center of the harness;
the first end of the harness comprising at least one suspension strap removably secured to the crossbar;
the second end of the harness comprising at least one body strap removably secured to the frame;
wherein the central body support comprises at least one rear aperture configured to accept a tail therethrough.

2) The animal suspension harness of claim 1, wherein the legs are telescopic.

3) The animal suspension harness of claim 1, wherein the rear aperture is oriented to align with the crossbar.

4) The animal suspension harness of claim 1, wherein a body strap is secured to opposing sides of the frame.

5) The animal suspension harness of claim 1, wherein the body straps are adjustable.

6) The animal suspension harness of claim 1, further comprising a plurality of D-rings disposed along the frame and the crossbar, wherein the plurality of D-rings are configured to pivotally affix the body strap and the suspension strap thereto.

7) The animal suspension harness of claim 1, wherein the harness further comprises a pair of main straps affixed to opposing sides thereof, wherein the pair of main straps are configured to provide support to the harness.

8) The animal suspension harness of claim 7, wherein the pair of main straps are adjustable in length.

9) The animal suspension harness of claim 2, further comprising a control mechanism disposed on each of the plurality of legs, wherein the control mechanism is configured to selectively move the plurality of legs between an extended position and a retracted position.

10) The animal suspension harness of claim 9, wherein the control mechanism comprises a grooved outer surface configured to increase frictional engagement therewith.

11) The animal suspension harness of claim 9, wherein the control mechanism is further comprised to lock the plurality of legs at a desired length.

12) The animal suspension harness of claim 1, wherein a height of the crossbar is selectively adjustable along a length of the pair of orthogonally adjacent legs.

13) The animal suspension harness of claim 1, further comprising a stopper disposed on the distal end of each of the plurality of legs, the stopper configured to increase frictional engagement with a support surface.

14) The animal suspension harness of claim 1, further comprising a paw rest extending between opposing legs of the plurality of legs.

15) The animal suspension harness of claim 1, wherein the frame is pivotally secured about the crossbar, such that the frame is selectively movably between a collapsed position and a deployed position.

16) The animal suspension harness of claim 15, further comprising a lever disposed on the frame, wherein the lever is configured to allow the frame to be moved between the collapsed position and the deployed position when actuated.
